(19) United States
(12) Patent Application Publication
(10) Pub. No.: US 2016/0225273 A1
(43) Pub. Date: Aug. 4, 2016

(54) METHODS AND SYSTEMS FOR EVALUATING USER

(71) Applicant: XEROX CORPORATION, Norwalk, CT (US)

(72) Inventors: Kaushik Baruah, Bangalore (IN); Kuldeep Yadav, Gurgaon (IN); Om D. Deshmukh, Bangalore (IN); William K. Stumbo, Fairport, NY (US)

(21) Appl. No.: 14/608,500

(22) Filed: Jan. 29, 2015

(51) Int. Cl. G09B 7/02; H04N 5/44; G06K 9/00

(52) U.S. Cl. CPC G09B 7/02; G06K 9/00315; H04N 5/44

(57) ABSTRACT

According to embodiments illustrated herein, there is provided a method and a mobile device for evaluating a user on a question. The method includes monitoring one or more inputs of the user, pertaining to at least one step performed for solving the question, by one or more sensors in a mobile device. While the user attempts the question, the one or more sensors also monitor one or more facial expressions of the user, which are analyzed using one or more image processing techniques. Thereafter, one or more processors in the mobile device determine if the at least one step is in accordance with a predefined set of rules deterministic of one or more correct steps involved in solving the question. Further, the one or more processors evaluate the user on the question based on the determination and the analysis of the one or more facial expressions.

### TECHNICAL FIELD

The presently disclosed embodiments are related, in general, to electronic learning (e-learning). More particularly, the presently disclosed embodiments are related to methods and systems for evaluating a user.

### BACKGROUND

With the advancement in telecommunication and penetration of internet among the masses, the education industry has seen unprecedented growth by reaching out to students/learners at remote locations. Education imparted through an online mode is well received by the masses and has immense potential for continued development. Formal education may not be complete without evaluating the students/learners on the topics taught. Further, to leverage the benefits of the online mode, such an evaluation may also be performed through the online mode. However, evaluating the students/learners through the online mode may pose certain challenges such as determining the concept/understanding gaps of the students/learners effectively.

### SUMMARY

According to embodiments illustrated herein, there is provided a method for evaluating a user on a question. The method includes, in a mobile device, monitoring, by one or more sensors in the mobile device, one or more inputs, received from the user, pertaining to at least one step performed for solving the question. The one or more sensors also monitor one or more facial expressions of the user, while the user is attempting the question, wherein the one or more facial expressions are analyzed using one or more image processing techniques. Thereafter, one or more processors in the mobile device determine if the at least one step is in accordance with a predefined set of rules deterministic of one or more correct steps involved in solving the question. Further, the one or more processors evaluate the user on the question based on at least the determination and the analysis of the one or more facial expressions.

According to embodiments illustrated herein, there is provided a mobile device for evaluating a user on a question. The mobile device includes one or more sensors configured to monitor one or more inputs, received from the user, pertaining to at least one step performed for solving the question. The one or more sensors are further configured to monitor one or more facial expressions of the user, while the user is attempting the question, wherein the one or more facial expressions are analyzed using one or more image processing techniques. The mobile device further includes one or more processors configured to determine if the at least one step is in accordance with a predefined set of rules deterministic of one or more correct steps involved in solving the question. The one or more processors are further configured to evaluate the user on the question based at least on the determination and the analysis of the one or more facial expressions.

According to embodiments illustrated herein, there is provided a computer program product for use with a mobile device. The computer program product comprises a non-transitory computer readable medium. The non-transitory computer readable medium stores a computer program code for evaluating a user on a question. The computer program code is executable by one or more processors in the mobile device to monitor, by one or more sensors in the mobile device, one or more inputs, received from the user, pertaining to at least one step performed for solving said question. Further, the one or more sensors monitor one or more facial expressions of the user, while the user is attempting the question, wherein the one or more facial expressions are analyzed using one or more image processing techniques. The computer program code is further executable by the one or more processors to determine if the at least one step is in accordance with a predefined set of rules deterministic of one or more correct steps involved in solving the question. Thereafter, the user is evaluated on the question based at least on the determination and the analysis of the one or more facial expressions.

### BRIEF DESCRIPTION OF DRAWINGS

The accompanying drawings illustrate the various embodiments of systems, methods, and other aspects of the disclosure. Any person with ordinary skills in the art will appreciate that the illustrated element boundaries (e.g., boxes, groups of boxes, or other shapes) in the figures represent one example of the boundaries. In some examples, one element may be designed as multiple elements, or multiple elements may be designed as one element. In some examples, an element shown as an internal component of one element may be implemented as an external component in another, and vice versa. Further, the elements may not be drawn to scale.

Various embodiments will hereinafter be described in accordance with the appended drawings, which are provided to illustrate and not to limit the scope in any manner, wherein similar designations denote similar elements, and in which:

FIG. 1 is a block diagram illustrating a system environment in which various embodiments may be implemented;

FIG. 2 is a block diagram that illustrates a computing device of a user, configured for evaluating the user on a question, in accordance with at least one embodiment;

FIG. 3 is a flowchart illustrating a method for evaluating a user on a question, in accordance with at least one embodiment;

FIG. 4 illustrates an example of a template associated with a question, in accordance with at least one embodiment;

FIG. 5 illustrates an example of a user-interface presenting a question related to the template to a user, in accordance with at least one embodiment;

FIGS. 6A, 6B, and 6C depict an example scenario of monitoring of one or more facial expressions of a user by one or more sensors of a computing device of the user, in accordance with at least one embodiment;

FIGS. 7A and 7B illustrate examples of user-interfaces that may be presented to a trainer/expert user on a computing device of the trainer/expert user, in at least one embodiment; and

FIG. 8 is a flow diagram illustrating the evaluation of the user on a question, in at least one embodiment.

### DETAILED DESCRIPTION

The present disclosure is best understood with reference to the detailed figures and description set forth herein. Various embodiments are discussed below with reference to the figures. However, those skilled in the art will readily appreciate that the detailed descriptions given herein with respect to the figures are simply for explanatory purposes as the methods and systems may extend beyond the described embodiments. For example, the teachings presented and the needs of a particular application may yield multiple alternative and suitable approaches to implement the functionality of any detail described herein. Therefore, any approach may extend beyond the particular implementation choices in the following embodiments described and shown.

References to “one embodiment,” “at least one embodiment,” “an embodiment,” “one example,” “an example,” “for example,” and so on indicate that the embodiment(s) or example(s) may include a particular feature, structure, characteristic, property, element, or limitation but that not every embodiment or example necessarily includes that particular feature, structure, characteristic, property, element, or limitation. Further, repeated use of the phrase “in an embodiment” does not necessarily refer to the same embodiment.

### DEFINITIONS

The following terms shall have, for the purposes of this application, the respective meanings set forth below.

“Question” refers to a statement of a problem that seeks for an answer from an individual. Examples of types of questions include, but are not limited to, multiple choice questions (MCQs), fill in the blanks type questions, one-word type questions, reading comprehension type questions, questions with one or more subjective answers, essay-type questions, and so on. Further, the question may relate to any topic/domain such as but not limited to, science, mathematics, art, literature, language, philosophy, and so on.

“One or more steps” refer to one or more procedural elements involved in solving a question. In an embodiment, a user may provide one or more inputs to perform a step to solve the question. For example, the one or more steps involved in solving a question of addition of two 2-digit numbers may include a step-1 for addition of the one's place digits and generation of a carry-over to the ten's place, a step-2 for addition of the ten's place digits with the generated carry-over from the one's place, and a step-3 for generating a hundred's place digit (in any) as a carry-over from the ten's place digit addition.

“Template” refers to a structure associated with a question (or a set of questions of similar type). In an embodiment, the template may be indicative of one or more steps required to solve the question and the sequencing of the one or more steps. In an embodiment, a trainer/expert user may provide the template and one or more questions associated with the template. In an embodiment, a predefined set of rules may be associated with the template, which may also be defined by the trainer/expert user.

“Predefined set of rules” refers to one or more conditions that may be checked to evaluate a user on a question. In an embodiment, the predefined set of rules may be formulated based on the template. In an embodiment, the predefined set of rules may include one or more predefined inputs (i.e., a correct answer associated with each step) pertaining to one or more correct steps for solving a question and a predefined sequence (i.e., a correct sequence of performing the steps) in which the one or more correct steps are to be performed for solving the question.

“Training” refers to imparting knowledge or skills pertaining to a particular domain of study such as, but not limited to, science, mathematics, art, literature, language, philosophy, and so on.

A “training content” refers to a text, an image, a video, a multimedia content, or any other type of content, which may be utilized for enhancing one or more skills of the user.

A “user” refers to an individual who may be evaluated on one or more questions. In an embodiment, the user may choose to attempt a question, which may then be presented to the user. The user may provide one or more inputs associated with performing one or more steps to solve the question. Based on an evaluation of the one or more inputs and a sequence of the one or more steps, the user may be evaluated on the question. Hereinafter, the terms “individual”, “user”, “trainee”, “learner”, and “evaluatee” have been used interchangeably.

A “trainer/expert user” refers to an individual (or an enterprise) who contributes to the evaluation of the users on the one or more questions. In an embodiment, the trainer/expert user may provide the one or more questions and the template associated with the one or more questions. Further, the trainer/expert user may define the predefined set of rules for the template. In an embodiment, the predefined set of rules may be utilizable for the evaluation of the users on the one or more questions. In an embodiment, the expert/trainer may also provide a training content for the training of the users based on the evaluation of the users.

A “Concept/sub-concept” may refer to a method/technique involved in performing at least one step out of the one or more steps required to solve the problem. For example, a question involving addition of two 2-digit numbers may have “single digit addition” and “addition with carry-over” as related concepts/sub-concepts.

“First set of concepts/sub-concepts” refers to one or more concepts/sub-concepts on which a user is evaluated as being unconversant.

“Second set of concepts/sub-concepts” refers to one or more concepts/sub-concepts on which a user is evaluated as being conversant.

A “degree of attentiveness” refers to an attention span of a user while the user solves a question. In an embodiment, the degree of attentiveness may be determined as a measure of time when the user is at least one of angry, frustrated, distracted, confused, or looking away from a screen of his/her computing device. Further, the degree of attentiveness may be determined based on a time delay between two subsequent inputs provided to a computing device while solving a problem. Thus, the degree of attentiveness may indicate whether the user is attentive and the extent to which the user is attentive.

A “feedback” refers to a response provided to a user while the user attempts a question on his/her computing device. In an embodiment, the feedback may be based on monitoring of one or more inputs received from the user, where the one or more inputs are related to one or more steps performed for solving the question. Further, in an embodiment, the feedback may also be based on monitoring of one or more facial expressions of the user. Examples of the feedback include, but are not limited to, a vibration alert provided by the user's computing device, an alert message/notification/prompt displayed on the screen of the user's computing device, an audio message played by the user's computing device, a video/animation played by the user's computing device, and so on.

A “revision” refers to an edit, a change, or a modification made by a user to one or more previous inputs related to at least one step performed for solving question. For example, the user may erase a previous input (e.g., using a backspace, or over-writing, etc.) and provide a new input as a revised input for the at least one step.

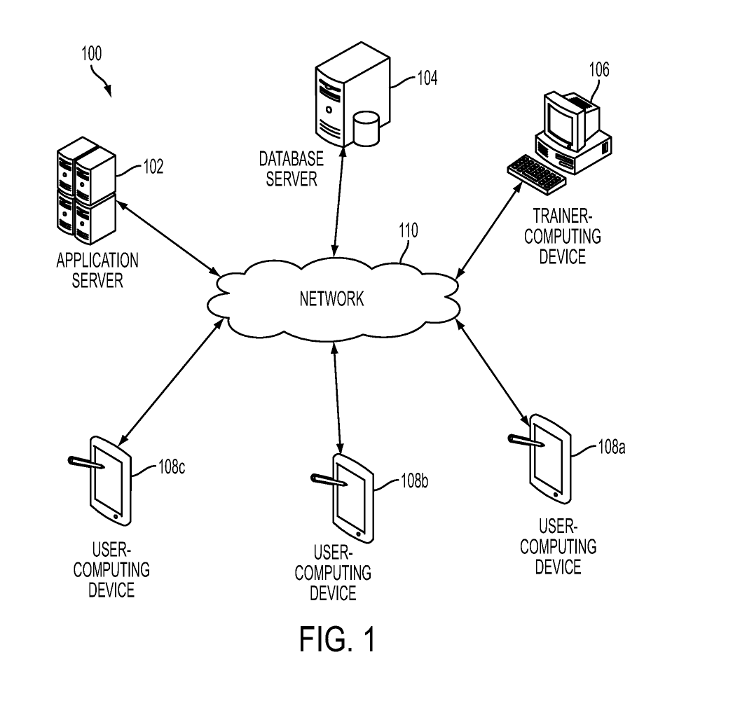

FIG. 1 is a block diagram of a system environment 100, in which various embodiments may be implemented. The system environment 100 includes an application server 102, a database server 104, a trainer-computing device 106, one or more user-computing devices (such as 108a, 108b, and 108c), and a network 110.

In an embodiment, the application server 102 may include programs/modules/computer executable instructions for evaluating one or more users on one or more questions. In an embodiment, the application server 102 may receive a template associated with the one or more questions from a trainer/expert user (using the trainer-computing device 106). Further, the application server 102 may receive a predefined set of rules pertaining to one or more correct steps involved in solving each of the one or more questions from the trainer-computing device 106. In an embodiment, the trainer/expert user may generate the predefined set of rules based on the template. Further, the one or more questions may either be provided by the trainer/expert user or may be generated by the application server 102 based on the template. The application server 102 may store the template, the one or more questions, and the predefined set of rules on the database server 104.

In an embodiment, the application server 102 may host an application or a web service for evaluating the one or more users. The application server 102 may present the application or the web service to the one or more users through a user interface on a respective user-computing device (e.g., 108a) of each user. The one or more users may request for evaluation on the one or more questions through the user interface. A person skilled in the art would appreciate that the user may register with the application or the web service prior to sending the request without departing from the scope of the disclosure. However, in an embodiment, the registration of the user may not be required and the user may send the request even without registering with the application or the web service. In an embodiment, the application or the web service may present the one or more questions to the user through the user interface. Through the user interface, the user may provide one or more inputs pertaining to at least one step performed for solving the question. In an embodiment, the evaluation of the user on the question may be based at least on whether the at least one step is in accordance with the predefined set of rules. In an embodiment, the evaluation of the user may further include performing a distractor analysis for the question attempted by the user to identify a first set of concepts/sub-concepts, in which the user is not conversant, and a second set of concepts/sub-concepts, in which the user is conversant. In an embodiment, the evaluation of the user may also be based on a monitoring of one or more facial expressions of the user by one or more sensors of the user-computing device (e.g., 108a). In an embodiment, based on the evaluation of the user, the application server 102 may provide a feedback to the user through the user interface of the user-computing device (e.g., 108a). Further, the application server 102 may also present a training content to the user through the user interface of the user-computing device (e.g., 108a) based on the evaluation of the user. In an embodiment, the training content may be stored on the database server 104 and the application server 102 may extract this training content from the database server 104 prior to sending the training content to the user-computing device (e.g., 108a). In an embodiment, the trainer/expert user may provide the training content.

Further, the application server 102 may collate the evaluations of the one or more users on the one or more questions over a period of time. In an embodiment, the application server 102 may send an evaluation report at an individual user-level and a collated evaluation report for the one or more users to the trainer/expert user on the trainer-computing device 106. Based on the evaluation reports, the trainer/expert user (using the trainer-computing device 106) may upload an additional template, one or more second questions related to the additional template, and/or a second training content on the application server 102.

Some examples of the application server 102 may include, but are not limited to, a Java application server, a .NET framework, and a Base4 application server.

In an embodiment, the database server 104 is configured to store at least the one or more questions and the template related to the one or more questions. Further, the database server 104 may also store the predefined set of rules. In addition, the database server 104 may store one or more training contents relevant to the one or more questions. In an embodiment, the database server 104 may receive a query from the application server 102, the trainer-computing device 106, and/or the user-computing device (e.g., 108a) to access/extract at least the one or more questions, the template, the predefined set of rules, and the one or more training contents from the database server 104. The database server 104 may be realized through various technologies such as, but not limited to, Microsoft® SQL Server, Oracle®, IBM DB2®, Microsoft Access®, PostgreSQL®, MySQL® and SQLite®, and the like. In an embodiment, the application server 102, the trainer-computing device 106, and/or the user-computing device (e.g., 108a) may connect to the database server 104 using one or more protocols such as, but not limited to, Open Database Connectivity (ODBC) protocol and Java Database Connectivity (JDBC) protocol.

A person with ordinary skills in the art would understand that the scope of the disclosure is not limited to the database server 104 as a separate entity. In an embodiment, the functionalities of the database server 104 can be integrated into the application server 102.

The trainer-computing device 106 is a computing device used by the trainer/expert user to upload the template, the one or more questions, and the predefined set of rules on the application server 102. Further, the trainer/expert user may upload the one or more training contents on the application server 102 using the trainer-computing device 106. Based on the evaluation of the one or more users on the one or more questions, the trainer/expert user may receive the evaluation report on the trainer-computing device 106 from the application server 102. Based on the evaluation report, the trainer/expert user may upload the additional template, the one or more second questions, and/or the second training content on the application server 102 using the trainer-computing device 106.

Examples of the trainer-computing device 106 include, but are not limited to, a personal computer, a laptop, a personal digital assistant (PDA), a mobile device, a tablet, or any other computing device.

A person having ordinary skill in the art would appreciate that the scope of the disclosure should not be limited to realizing the trainer-computing device 106 and the application server 102 as separate entities. In an embodiment, the application server 102 may be realized within the trainer-computing device 106 as an application program hosted by or running on the trainer-computing device 106.

The user-computing device (e.g., 108a) is a computing device used by a user who is evaluated on the one or more questions. The user-computing device (e.g., 108a) is configured to present the user interface (of the application or web service hosted by the application server 102) to the user. The user may request for the evaluation on the one or more questions through the user interface. A person skilled in the art would appreciate that the user may register with the application or the web service prior to sending the request without departing from the scope of the disclosure. However, in an embodiment, the registration of the user may not be required and the user may send the request even without registering with the application or the web service. Thereafter, the user is presented the one or more questions through the user interface on the user-computing device (e.g., 108a). In an embodiment, the user-computing device (e.g., 108a) may include one or more sensors such as, but not limited to, a touch screen, an accelerometer, a gyroscope, an audio input device, or a camera/video recorder. In an embodiment, through the user interface, the user may provide the one or more inputs pertaining to the at least one step performed for solving the question. In an embodiment, the one or more sensors may be configured to monitor such one or more inputs received from the user. Thereafter, the user-computing device (e.g., 108a) may determine whether the at least one step is in accordance with the predefined set of rules pertaining to the one or more correct steps for solving the question. In an embodiment, the predefined set of rules may include, but are not limited to, one or more predefined inputs pertaining to each of the one or more correct steps and a predefined sequence in which the one or more correct steps are to be performed to solve the question. In an embodiment, the user-computing device (e.g., 108a) may receive the predefined set of rules from the application server 102 (or the database server 104), which the user-computing device (e.g., 108a) may store in a memory associated with the user-computing device (e.g., 108a). Alternatively, the user-computing device (e.g., 108a) may send information pertaining to the one or more inputs of the at least one step to the application server 102 for the determination that whether the at least one step is in accordance with the predefined set of rules. Thereafter, based on the determination of the at least one step being in accordance with the predefined set of rules, the user may be evaluated on the question. In an embodiment, the evaluation of the user on the question may include determining at least a first set of concepts/sub-concepts, with which the user is not conversant, and a second set of concepts/sub-concepts, with which the user is conversant.

Further, in an embodiment, the one or more sensors in the user-computing device (e.g., 108a) may monitor one or more facial expression of the user, while the user is attempting the question. In an embodiment, the user-computing device (e.g., 108a) may analyze the one or more facial expressions using one or more image processing techniques. The user-computing device (e.g., 108a) may determine at least a degree of attentiveness of the user while the user is solving the question based at least on the analysis of the one or more facial expressions. In an embodiment, the degree of attentiveness may correspond to, but is not limited to, a measure of time for which the user is at least one of bored, distracted, frustrated, confused, or not looking at a screen of the user-computing device (e.g., 108a). In an embodiment, the user may be provided a feedback through the user-interface of the user-computing device (e.g., 108a) based at least on the evaluation of the user and/or the analysis of the one or more facial expressions of the user.

Further, in an embodiment, the user-computing device (e.g., 108a) may determine a number of revisions pertaining to the at least one step based on the monitoring of the one or more inputs. In addition, in an embodiment, the user-computing device (e.g., 108a) may monitor a time elapsed between providing the one or more inputs pertaining to the at least one step and one or more second inputs pertaining to subsequent steps. Further, based on the evaluation of the user, the user-computing device (e.g., 108a) may present a training content to the user, which the user-computing device (e.g., 108a) may receive from the application server 102 or the database server 104. In addition, in an embodiment, the user-computing device (e.g., 108a) may send an evaluation report of the user based on the evaluation of the user on the question to the trainer/expert user on the trainer-computing device 106. The user-computing device (e.g., 108a) may send this evaluation report either directly to the trainer-computing device 106 or through the application server 102, which may collate such evaluation reports received from the one or more users and send these reports, in addition to aggregate level reports of the one or more users to the trainer-computing device 106.

Examples of the user-computing device (e.g., 108a) may include, but are not limited to, a personal computer, a laptop, a personal digital assistant (PDA), a mobile device, a smartphone, a mobile phone, a tablet, or any other computing device. In an embodiment, the user-computing device (e.g., 108a) may be a mobile device that includes a touch screen to receive the one or more inputs from the user and a front-facing camera to monitor the one or more facial expressions of the user.

A person having ordinary skill in the art would understand that the scope of the disclosure is not limited to the user-computing device (e.g., 108a) and the application server 102 as separate entities. In an embodiment, the functionality of both the user-computing device 108 and the application server 102 may be integrated in a single computing device.

Further, a person skilled in the art would appreciate that the system environment 100 of FIG. 1 depicts three user-computing devices (i.e., 108a, 108b, and 108c) for illustrative purposes only and the scope of the disclosure is not limited to only three user-computing devices. The system environment 100 of the disclosure may be implemented with any number of user-computing devices without departing from the spirit of the disclosure.

The network 110 corresponds to a medium through which content and messages flow between various devices of the system environment 100 (e.g., the application server 102, the database server 104, the trainer-computing device 106, and the one or more user-computing devices (such as 108a, 108b, and 108c)). Examples of the network 110 may include, but are not limited to, a Wireless Fidelity (Wi-Fi) network, a Wireless Area Network (WAN), a Local Area Network (LAN), or a Metropolitan Area Network (MAN). Various devices in the system environment 100 can connect to the network 110 in accordance with various wired and wireless communication protocols such as Transmission Control Protocol and Internet Protocol (TCP/IP), User Datagram Protocol (UDP), and 2G, 3G, or 4G communication protocols.

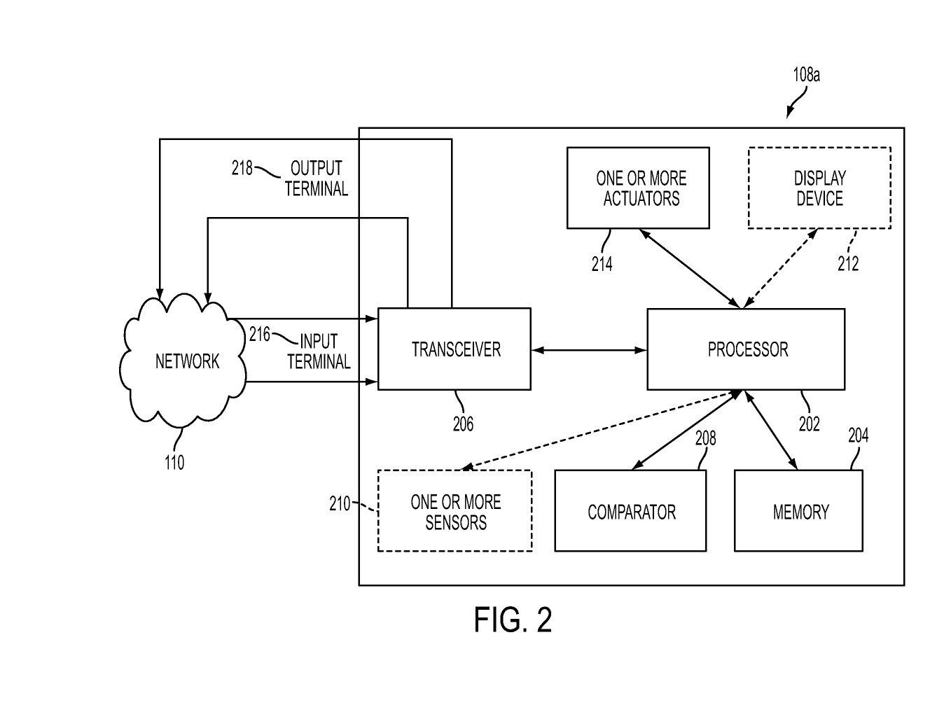

FIG. 2 is a block diagram that illustrates the user-computing device (e.g., 108a) configured for evaluating the user on the question, in accordance with at least one embodiment.

The user-computing device (e.g., 108a) includes a processor 202, a memory 204, a transceiver 206, a comparator 208, one or more sensors 210, a display device 212, and one or more actuators 214. The processor 202 is coupled to the memory 204, the transceiver 206, the comparator 208, the one or more sensors 210, the display device 212, and the one or more actuators 214. The transceiver 206 is connected to the network 110 through an input terminal 216 and an output terminal 218.

The processor 202 includes suitable logic, circuitry, and/or interfaces that are operable to execute one or more instructions stored in the memory 204 to perform predetermined operations. The processor 202 may be implemented using one or more processor technologies known in the art. Examples of the processor 202 include, but are not limited to, an x86 processor, an ARM processor, a Reduced Instruction Set Computing (RISC) processor, an Application Specific Integrated Circuit (ASIC) processor, a Complex Instruction Set Computing (CISC) processor, or any other processor.

The memory 204 stores a set of instructions and data. Some of the commonly known memory implementations include, but are not limited to, a random access memory (RAM), a read only memory (ROM), a hard disk drive (HDD), and a secure digital (SD) card. Further, the memory 204 includes the one or more instructions that are executable by the processor 202 to perform specific operations. It is apparent to a person with ordinary skills in the art that the one or more instructions stored in the memory 204 enable the hardware of the user-computing device (e.g., 108a) to perform the predetermined operations.

The transceiver 206 transmits and receives messages and data to/from various components of the system environment 100 (e.g., the application server 102, the database server 104, and the trainer-computing device 106) over the network 110. In an embodiment, the transceiver 206 is coupled to the input terminal 216 and the output terminal 218 through which the transceiver 206 may receive and transmit data/messages respectively. Examples of the transceiver 206 may include, but are not limited to, an antenna, an Ethernet port, a USB port, or any other port that can be configured to receive and transmit data. The transceiver 206 transmits and receives data/messages in accordance with the various communication protocols such as, TCP/IP, UDP, and 2G, 3G, or 4G communication protocols.

The comparator 208 is configured to compare at least two input signals to generate an output signal. In an embodiment, the output signal may correspond to either ‘1’ or ‘0’. In an embodiment, the comparator 208 may generate output ‘1’ if the value of a first signal (from the at least two signals) is greater than a value of the second signal (from the at least two signals). Similarly, the comparator 208 may generate an output ‘0’ if the value of the first signal is less than the value of the second signal. In an embodiment, the comparator 208 may be realized through either software technologies or hardware technologies known in the art. Though, the comparator 208 is depicted as independent from the processor 202 in FIG. 2, a person skilled in the art would appreciate that the comparator 208 may be implemented within the processor 202 without departing from the scope of the disclosure.

The one or more sensors 210 are configured to monitor the one or more actions performed by the user. In an embodiment, the one or more actions may comprise at least one of an input provided for the solving a question, one or more facial expressions, etc. In an embodiment, the user may provide the one or more inputs through the user-interface of the user-computing device (e.g., 108a). In an embodiment, the one or more sensors 210 may be inbuilt into the display of the user-computing device (e.g., 108a) on which the user-interface is being displayed. For example, the user-interface may be a touch screen that may be embedded with the display of the user-computing device (e.g., 108a). In an embodiment, an output from the touch screen sensor may be processed by the processor 202 to perform the monitoring of the one or more inputs. In another embodiment, the one or more sensors 210 may further include sensors that may monitor at least one or more facial expressions of the user. For example, the one or more sensors 210 may include a camera/video recorder, which may record an image/video of the user, while the user attempts a question through the user-interface. Based on the user's image/video, so recorded, the one or more facial expressions may be monitored. Examples of the one or more sensors 210 include, but are not limited to, a touch screen, an accelerometer, a gyroscope, an audio input device, or a camera/video recorder.

The display device 212 is configured to display the user-interface of the user-computing device (e.g., 108a) to the user. In an embodiment, the display device 212 may be inbuilt within the user-computing device (e.g., 108a). Alternatively, the display device 212 may be external to the user-computing device (e.g., 108a), and may be communicatively coupled to the user-computing device (e.g., 108a). In an embodiment, the display device 212 may be realized through several known technologies such as, but not limited to, Cathode Ray Tube (CRT) based display, Liquid Crystal Display (LCD), Light Emitting Diode (LED) based display, Organic LED display technology, and Retina display technology. In addition, in an embodiment, the display device 212 may be capable of receiving the one or more inputs from the user. In such a scenario, the display device 212 may be a touch screen that enables the user to provide the one or more inputs. In an embodiment, the touch screen may correspond to at least one of a resistive touch screen, a capacitive touch screen, or a thermal touch screen. Further, in an embodiment, the touch-screen may receive the one or more inputs through a virtual keypad, a stylus, a gesture, and/or a touch based input.

The one or more actuators 214 may be configured to provide a feedback to the user. In an embodiment, the feedback may at least include a vibration feedback. In such a scenario, the one or more actuators 214 may include one or more vibration actuators that may produce a vibratory movement (e.g., a vibratory pulse for a predetermined time interval) of the user-computing device (e.g., 108a) at a predefined frequency. In an embodiment, the one or more actuators 214 may be realized through one or more piezoelectric components. Examples of the piezoelectric components include, but are not limited to, stack actuators and stripe actuators.

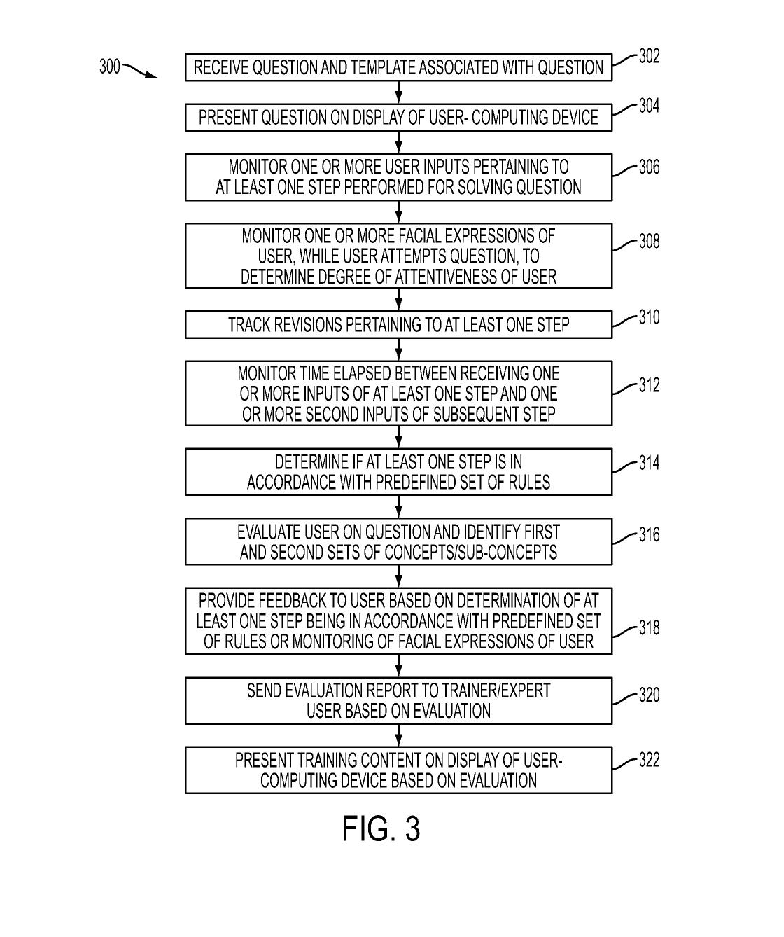

In operation, in an embodiment, the processor 202 may receive the one or more questions and the template related to the one or more questions from the application server 102 through the transceiver 206. In addition, the processor 202 may receive the predefined set of rules from the application server 102 through the transceiver 206. The processor 202 may store the template, the one or more questions, and the predefined set of rules in the memory 204. In an embodiment, the processor 202 may present a question, from the one or more questions, to the user through the user-interface on the display device 212 by utilizing the template. Thereafter, the user may provide the one or more inputs pertaining to the at least one step for solving the question through the user-interface. In an embodiment, the one or more sensors 210 may monitor the one or more inputs received from the user. The processor 202 may then determine whether the at least one step conforms to the predefined set of rules deterministic of the one or more correct steps involved in solving the question. In an embodiment, prior to such determination, the processor 202 may retrieve the predefined set of rules from the memory 204. Thereafter, based on the determination of the at least one step being in accordance with the predefined set of rules, the processor 202 may evaluate the user on the question. In addition, in an embodiment, the one or more sensors 210 may also monitor the one or more facial expressions of the user, while the user is solving the question. The processor 202 may analyze the one or more facial expressions using one or more image processing techniques to determine the degree of attentiveness of the user. In an embodiment, the processor 202 may provide a feedback to the user though the user-interface (and/or through the one or more actuators 214) based at least on the evaluation of the user on the question and/or the analysis of the one or more facial expressions (i.e., the degree of attentiveness). An embodiment of a method for evaluating a user on a question has been explained further in conjunction with FIG. 3.

FIG. 3 is a flowchart 300 illustrating a method for evaluating the user on the question, in accordance with at least one embodiment. The flowchart 300 is described in conjunction with FIG. 1 and FIG. 2.

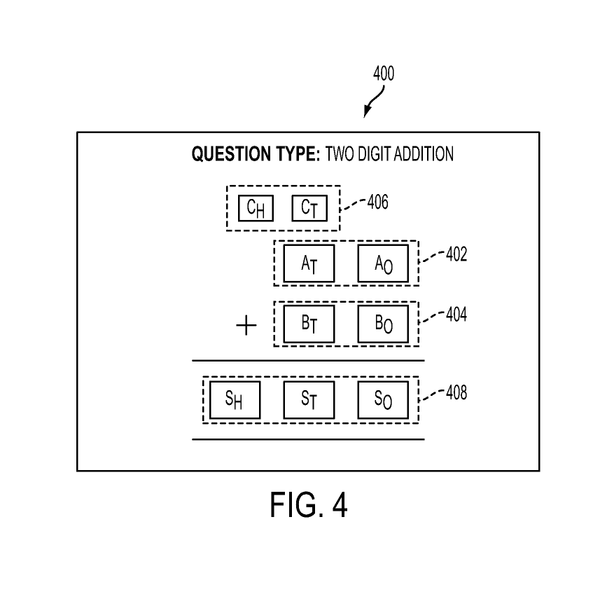

At step 302, the question and the template associated with the question are received. In an embodiment, the processor 202 may receive the question and the template from the application server 102 (or the database server 104) through the transceiver 206. In addition, the processor 202 may receive the predefined set of rules from the application server 102 (or the database server 104). The processor 202 may store the question, the template, and the predefined set of rules in the memory 204. In an embodiment, prior to receiving the question, the user may request the application or web service (hosted by the application server 102) for evaluation on the question, through the user-interface of the user-computing device (e.g., 108a). A person skilled in the art would appreciate that the user may register with the application or the web service prior to sending the request without departing from the scope of the disclosure. However, in an embodiment, the registration of the user may not be required and the user may send the request even without registering with the application or the web service. An example of the template has been explained in conjunction with FIG. 4.

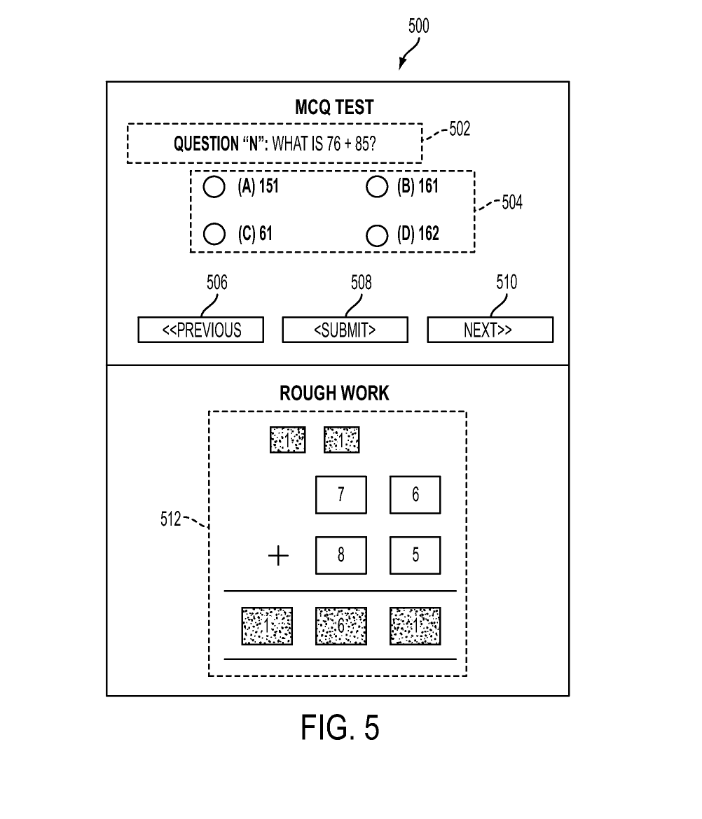

At step 304, the question is presented on the display device 212 of the user-computing device (e.g., 108a). In an embodiment, the processor 202 is configured to present the question through the user-interface on the display device 212. An example of the user-interface presenting the question has been explained in conjunction with FIG. 5.

At step 306, the one or more user inputs pertaining to the at least one step are monitored. In an embodiment, the one or more sensors 210 are configured to monitor the one or more inputs received from the user through the user-interface. For example, the one or more sensors 210 include a touch screen through which the user provides the one or more inputs. In such a scenario, the touch screen may monitor a value associated with each input, a location on the screen at which each input is provided, and a timestamp associated with each input. For instance, the question is that of addition of two 2-digit numbers. In this case, the at least one step may be an addition of the one's digits of the two numbers followed by a generation of a carry-over digit, if applicable. The user may provide the answer of one's digit addition and the carry-over digit as the one or more inputs pertaining to the at least one step. The one or more sensors 210 may monitor each such user input and all subsequent inputs provided by the user.

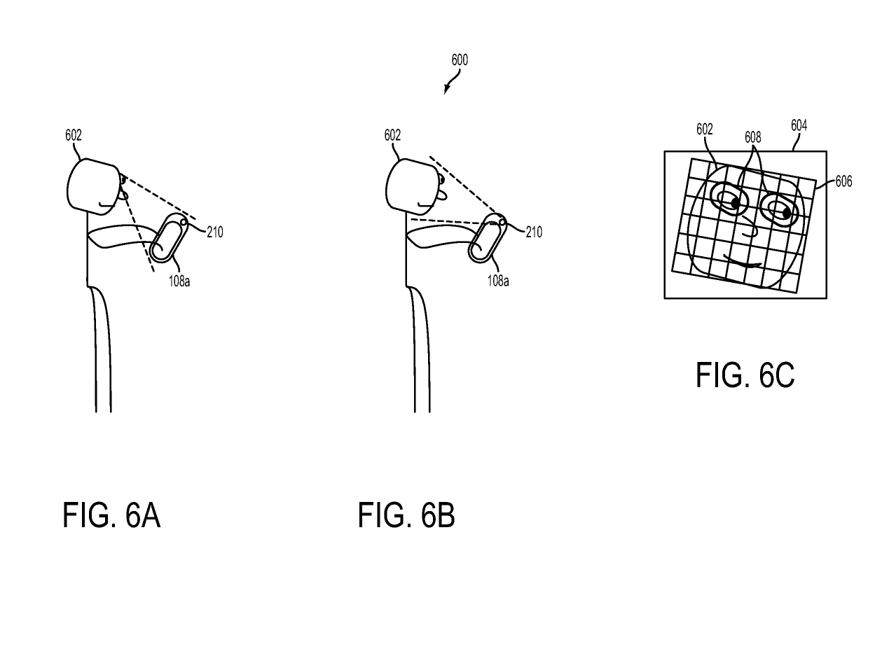

At step 308, the one or more facial expressions of the user are monitored. In an embodiment, the one or more sensors 210 are configured to monitor the one or more facial expressions of the user, while the user is attempting the question. For example, the one or more sensors 210 include a camera/video recorder. In such a scenario, the camera/video recorder may record an image/video of the user, while the user is attempting the question. The one or more facial expressions of the user may be monitored based on the recorded image/video of the user. In an embodiment, the processor 202 may determine at least the degree of attentiveness of the user based on the monitoring of the one or more facial expressions of the user. In an embodiment, the degree of attentiveness may include, but is not limited to, a measure of a time for which the user is at least one of bored, distracted, frustrated, confused, or not looking towards the display device 212 of the user-computing device (e.g., 108a). In an embodiment, to determine the degree of attentiveness, the processor 202 may analyze the image/video capturing the one or more facial expressions of the user by utilizing one or more image processing techniques and/or one or more machine learning techniques known in the art. Examples of the one or more image processing techniques include, but are not limited to, Viola-Jones object detection framework, invariant face detection with support vector machines, robust face detection at video frame rate based on edge orientation features, robust face detection using local gradient patterns and evidence accumulation, Scale Invariant Feature Transform (SIFT), template based feature detection, and regressive feature classification. Examples of the one or more machine learning techniques include, but are not limited to, neural networks, radial basis functions, support vector machines (SVM), Naïve Bayes, and k-nearest neighbor algorithm. An example scenario of the monitoring of the one or more facial expressions of the user has been described in conjunction with FIGS. 6A, 6B, and 6C.

A person skilled in the art would understand the scope of the disclosure is not limited to determining the degree of attentiveness of the user, as discussed above. One or more other techniques may be used to determine the degree of attentiveness without departing from the spirit of the disclosure.

For example, the user reads the question and makes a grim face. This may be indicative of the user not knowing how to proceed further and solve the question. However, if the user is confident on reading the question, the user's facial expressions may change to that of excitement, smile, triumph, etc. Further, if the user is feeling bored or distracted, the user may yawn or make a face of indifference. As discussed above, the one or more sensors 210 may monitor the one or more facial expressions of the user while the user solves the question. The processor 202 may then determine the degree of attentiveness based on the one or more facial expressions, so monitored. The degree of attentiveness may be indicative of how the user's temperament varies with time. For instance, the user has a grim face while he/she provides inputs for an initial step of the question as the user may not be very confident with his/her approach. However, as the user progresses through solving the question, the user's expressions may change to that of confidence (e.g., smile). Thus, the user may have figured out how to solve the question and may now be more confident than before.

Further, if based on the monitoring of the one or more facial expressions of the user, the processor 202 determines that the user's expressions are that of anger or dejection, the processor 202 may determine that the user is either frustrated or confused. In such a scenario, the user may not as such be inattentive while solving the question, but the overall confidence level of the user may be low. Thus, the user may not be conversant one or more core concepts involved in solving the question. However, a person skilled in the art would appreciate that the user may also be frustrated or confused when the user is not fully engaged in solving the question.

A person skilled in the art would appreciate that the steps 306 and 308 may be performed in any order or may be performed in parallel without departing from the scope of the disclosure.

At step 310, revisions pertaining to the at least one step are tracked. In an embodiment, the one or more sensors 210 may track each revision made by the user for the at least one step and maintain a count of such revisions in the memory 204. The one or more sensors 210 may also record a timestamp associated with each such revision in the memory 204. In an embodiment, the processor 202 may determine a number of revisions pertaining to the at least one step based on the count of such revisions stored in the memory 204. The number of revisions pertaining to the at least one step may correspond to a number of times that the user changes his/her inputs pertaining to the at least one step. For example, in a question of addition of two 2-digit numbers, the user may change the answer of the ten's digit addition if he/she forgets to initially take into account the carry-over digit from the one's digit addition. The number of times the user makes such changes to his/her inputs corresponds to the number of revisions (which in this case may be 1).

Further, in an embodiment, the processor 202 may also monitor a time taken by the user to make each revision related to the at least one step based on the timestamps of such revisions in the memory 204. In an embodiment, the time taken to make the revisions may be utilized to determine a confidence level of the user on the at least one step. The confidence level may in-turn be used in the evaluation of the user on the question. For example, the user makes 3 edits related to the at least one step. The user takes 10 seconds to make the first edit, 25 seconds to make the second edit, and 45 second to make the final edit. Thus, the processor 202 may determine that the first edit was made quickly be the user, and hence this may be an impulsive correction. However, the user may have thought through on the subsequent edits. The user's confidence level on the at least one step may be determined as relatively low in the above scenario as the time taken to make subsequent edits increases. However, a person skilled in the art would appreciate that any heuristic may be used to determine the confidence level of the user on the at least one step without departing from the scope of the disclosure.

At step 312, a time elapsed between receiving the one or more inputs of the at least one step and one or more second inputs for a subsequent step is determined. In an embodiment, the processor 202 is configured to determine the time elapsed between receiving the one or more inputs and the one or more second inputs. In an embodiment, the processor 202 may monitor the timestamp at which the question is presented to the user on the user-interface. As discussed above, the one or more sensors 210 may monitor the one or more inputs. Further, the one or more sensors 210 may track a timestamp associated with each input and store the timestamp in the memory 204. Based on the timestamps of the various inputs, the processor 202 may determine the elapsed time as an offset from the timestamp at which the question is presented to the user. For instance, the question is presented to the user at a timestamp of 12:01:33 pm (TS₀). The user provides 2 inputs (I₁, I₂) for the at least one step at timestamps 12:02:03 pm (TS₁) and 12:02:58 pm (TS₂), while the user provides 3 inputs (I₃, I₄, I₅) for the subsequent step at timestamps 12:04:50 pm (TS₃), 12:05:55 pm (TS₄), and 12:06:08 pm (TS₅). Thus, the processor 202 may determine the time elapsed between the two steps as the time lag between inputs I₂ and I₃, i.e., 1 minute 52 seconds (or TS₃-TS₂). Further, the processor 202 may determine the time taken by the user to complete each step. In the above example, the processor 202 may determine that the time taken by the user to complete the at least one step as 1 minute 25 seconds (or TS₂-TS₀) and the time taken by the user to complete the subsequent step as 3 minutes 10 seconds (or TS₅-TS₂).

A person skilled in the art would appreciate that the steps 310 and 312 may be performed in any order or may be performed in parallel without departing from the scope of the disclosure.

At step 314, it is determined that whether the at least one step is in accordance with the predefined set of rules deterministic of the one or more correct steps of solving the question. In an embodiment, the processor 202 is configured to determine that whether the at least one step conforms to the predefined set of rules. The processor 202 may extract the predefined set of rules from the memory 204. In an embodiment, the predefined set of rules may include, but are not limited to, one or more predefined inputs pertaining to each of the one or more correct steps and a predefined sequence in which the one or more correct steps are to be performed to solve the question. In an embodiment, the processor 202 may utilize the comparator 208 to compare the one or more inputs pertaining to the at least one step with the one or more predefined inputs pertaining to the one or more correct steps. Further, the processor 202 may determine whether the order of the at least one step among the steps performed by the user is same as the predefined sequence of the one or more correct steps. For example, the question is that of addition of two 2-digit numbers. The predefined set of inputs may include the final answer of the addition, i.e., the digits at the one's place, ten's place, and hundred's place (if applicable). The predefined set of inputs may also include the intermediate carry-over digits, if inputs corresponding to the intermediate carry-over digits are acceptable from the user solving the question. Further, the one or more correct steps may include a step-1 for adding the digits at the one's place, a step-2 for generating a carry-over digit from the one's digit addition, a step-3 for adding the digits at the ten's place (and the generated carry-over digit, if applicable), a step-4 for generating a carry-over digit from the ten's digit addition. The predefined sequence of the one or more correct steps may include step-1, step-2, step-3, and step-4, in that order. Now, considering a scenario in which the user provides a correct final answer but the order in which he/she performs the steps is different from the predefined sequence, the user's answer may not be evaluated as completely correct. Alternatively, the user may follow a correct sequencing of the individual steps but may make a mistake in one of the steps. In such a case, the user's answer may be evaluated as partially correct subject to the number of mistakes so committed.

A person skilled in the art would appreciate that the steps 306 through 312 may be iterated multiple times before the user is evaluated on the question, in accordance with step 314. For example, the at least one step includes 3 consecutive steps A, B, and C of the question. The steps 306 through 312 may be iterated for each of these 3 steps A, B, and C, after which the step 314 may be performed to evaluate the user on the question. Further, steps 306 through 312 may be iterated for each subsequent step, and the user may be evaluated in a manner similar to that described in step 314.

At step 316, the user is evaluated on the question and the first and the second sets of concepts/sub-concepts are identified. In an embodiment, the processor 202 is configured to evaluate the user on the question based on the determination of the at least one step being in conformance to the predefined set of rules. In an embodiment, a weightage may be assigned to each step of the question. Further, a weightage may also be assigned to the sequencing of steps. In an embodiment, the trainer/expert user may assign these weightages, and provide the weightages along with the template and the predefined set of rules. Based on the respective weightages of the individual steps and the sequencing of steps, the number of mistakes committed by the user on the individual steps of the question, and whether or not the user follows the correct sequencing of steps, the processor 202 may score the user on the question. For example, a question may be solved in three steps. The processor 202 may assign an equal weightage for each step and a separate weightage for the sequencing of the steps. For instance, the processor 202 may assign a weight of 0.2, 0.2, and 0.2 for each step and a weight of 0.4 for the sequencing of the steps. Thus, if the user commits a mistake on two steps, and performs the other step correctly and follows the correct sequence of steps, the processor 202 may score the user as 0.2+0.4, i.e., 0.6 out of 1 on the question.

Further, the processor 202 may determine the first set of concepts/sub-concepts with which the user is not conversant, and the second set of concepts/sub-concepts with which the user is conversant. For example, in a question of addition of two 2-digit numbers, the user commits a mistake in the ten's digit place by providing a wrong carry-over digit from the addition of the one's digits. However, the user may provide a correct answer in the one's place. Thus, the processor 202 may determine that the user may not be conversant with the concept of single digit addition with carry-over, though the user may be conversant with addition of single digit numbers, without carry-over. Thus, in this scenario, the first set of concepts/sub-concepts (with which the user is not conversant) may include “single digit addition with carry-over”, while the second set of concepts/sub-concepts (with which the user is conversant) may include “addition of single digit numbers, without carry-over”.

In an embodiment, the processor 202 may evaluate the user by performing a distractor analysis of the user to determine the first and the second set of concepts/sub-concepts. In an embodiment, each of the one or more steps required to solve the question may have one or more associated distractors, which may be indicative of the concepts with which the user is conversant or unconversant. In the above example of addition with carry-over, the user may provide wrong inputs for the step of calculating the carry-over digit, may forget to calculate the carry-over, or may provide the correct inputs for carry-over digit but may not incorporate the carry-over digit into the next digit's addition. In all such scenarios, the processor 202 may identify the concept of “single digit addition with carry-over” as a concept with which the user is not conversant. Further, in an embodiment, the processor 202 may validate the result of the distractor analysis based on the degree of attentiveness of the user. For example, if the degree of attentiveness of the user indicates that the user is bored, distracted, or is looking away from the display device 212 while performing the at least one step, the processor 202 may attribute a mistake committed by the user on the at least one step to the user's inattentiveness and not to the user being unconversant with the concept/sub-concept related to the step. In such a scenario, the user may be presented with a feedback (as described in step 318) and given a chance to change his/her inputs on the step.

A person skilled in the art would appreciate that the trainer/expert user may provide a mapping between distractors and the concepts/sub-concepts related to the respective distractors. In an embodiment, the processor 202 may identify the first set of concepts/sub-concepts and the second set of concepts/sub-concepts based on the evaluation of the user on the question (i.e., the individual steps and the sequencing of the steps) and the mapping between the individual steps and concepts/sub-concepts provided by the trainer/expert user.

A person skilled in the art would appreciate that the examples provided in the disclosure are for illustrative purposes only and should not serve to restrict the scope of the disclosure. The disclosure may be implemented for questions of any field/domain such as, but not limited to, mathematics, science, political sciences, sociology, physiology, psychology, social sciences, history, languages, computer science, literature, arts, etc.

Further, a person skilled in the art would appreciate that the evaluation of the user may be either in real-time, i.e., the at least one step is checked against the predefined set of rules as the user provides the one or more inputs. Alternatively, the evaluation of the user may be performed once all the steps of the question have been performed by the user, i.e., the user has provided inputs for all the steps of the question.

At step 318, a feedback is provided to the user. In an embodiment, the processor 202 is configured to provide the feedback to the user through the user-interface of the user-computing device (e.g., 108a). In an embodiment, the feedback may be based on the evaluation of the user (i.e., based on the determination of the at least one step being in accordance with the predefined set of rules) and/or the monitoring of the one or more facial expressions of the user. In a scenario where the evaluation of the user is in real-time, (i.e., the at least one step is checked against the predefined set of rules as the user provides the one or more inputs), the processor 202 may provide the user with the feedback in real-time, i.e., as soon as the user provides the one or more inputs. For example, in a question of addition of two 2-digit numbers, the at least one step includes the addition of the one's digit and the generation of the carry-over digit from the one's digit addition. If the user makes a mistake in the sequencing of steps, (e.g., by adding the ten's digits first) or makes a mistake in one of the inputs itself (e.g., provides a wrong carry-over digit or a wrong one's place digit), the processor 202 may provide the user a feedback. In an embodiment, the feedback provided by the processor 202 may at least include, but is not limited to, a prompt on the display device 212 indicative of a hint to the question or a mistake being performed by the user. In an embodiment, the feedback may also include an alert to the user in the form of a vibration alert (e.g., by using the one or more actuators 214 within the user-computing device (e.g., 108a), a voice alert (e.g., by playing an audio message indicative of the feedback, or to encourage the user), or an audio/video prompt (e.g., an animation for encouraging the user, or providing a hint to the user in solving the question).

A feedback may also be provided to the user in a scenario where the user solves an essay-type question by providing handwritten inputs through the user interface of the user-computing device (e.g., 108a). In such a scenario, the user may be required to maintain the user-computing device (e.g., 108a) in a stable upright position/orientation while solving the question. The one or more sensors 210 (e.g., an accelerometer) may monitor the position/orientation of the user-computing device (e.g., 108a) while solving the question. If the user does not maintain a correct position/orientation of the user-computing device (e.g., 108a), the processor 202 may provide a feedback to the user, for example, in the form of a vibration alert (through the one or more actuators 214 of the user-computing device (e.g., 108a), or a prompt on the display device 212.

Further, in a scenario where the evaluation of the user is performed after all the inputs associated with all the steps of the question are received, the processor 202 may provide a feedback for the entire question as a whole and the individual steps in particular. In an embodiment, in both the scenarios (i.e., real-time evaluation and the evaluation at the end of all the steps), the processor 202 may provide a comprehensive feedback for the question to user (in addition to the feedback pertaining to the at least one step), after the user completes all steps of the question. For example, the comprehensive feedback may include number and types of mistakes committed, the total score on the question, the total time taken on the question and the time taken on the individual steps, an indication of the first concept/sub-concept (on which the user was found to be unconversant) and the second concept/sub-concept (on which the user was found to be conversant), the degree of attentiveness of the user when the user attempted the individual steps, and so on.

Further, in an embodiment, the processor 202 may provide the user a feedback based on the monitoring of the one or more facial expressions of the user. As explained above (in step 308), the processor 202 may determine the degree of attentiveness of the user based on the monitoring of the one or more facial expressions of the user. The processor 202 may provide a feedback to the user based on the degree of attentiveness of the user at that point in time. For example, if the degree of attentiveness of the user is indicative of the user being bored, the processor 202 may provide a motivating quote as the feedback to encourage the user. Further, if the degree of attentiveness indicates that the user is distracted or looking away from the screen (i.e., the display device 212 of the user-computing device (e.g., 108a), the processor 202 may provide the user with an animation (e.g., an image/video showing the one or more facial expressions of the user) or a comic character to liven up the interest of the user and bring back his/her attention to the question. In addition (or alternatively), the processor 202 may also provide a vibration alert to the user (through the one or more actuators 214 of the user-computing device (e.g., 108a) in case the user is bored, frustrated, distracted, or looking away from the screen (i.e., the display device 212 of the user-computing device, e.g., 108a).

A person skilled in the art would appreciate that the examples of the feedback provided to the user are for illustrative purposes only and should not be construed to limit the scope of the disclosure. The disclosure may be implemented by providing feedback of other types to the user without departing from the scope of the disclosure.

At step 320, an evaluation report is sent to the trainer/expert user based on the evaluation of the user. In an embodiment, the processor 202 is configured to send the evaluation report to the trainer/expert user on the trainer-computing device 106 through the transceiver 206. In an embodiment, the processor 202 may either send the evaluation report directly to the trainer-computing device 106 of the trainer/expert user. Alternatively, the processor 202 may send the evaluation report to the application server 102, which may then forward the evaluation report to the trainer-computing device 106. In an embodiment, the evaluation report may include, but is not limited to, a feedback pertaining to the at least one step, the number of revisions pertaining to the at least one step, a time elapsed between a first revision and a second revision pertaining to said at least one step, a time elapsed between the receipt of the one or more inputs pertaining to the at least one step and one or more second inputs pertaining to the step subsequent to the at least one step (or time taken in each step), a sequence in which one or more steps are performed by the user for solving the question, a step skipped by the user while solving the question, and the degree of attentiveness of the user while solving the question.

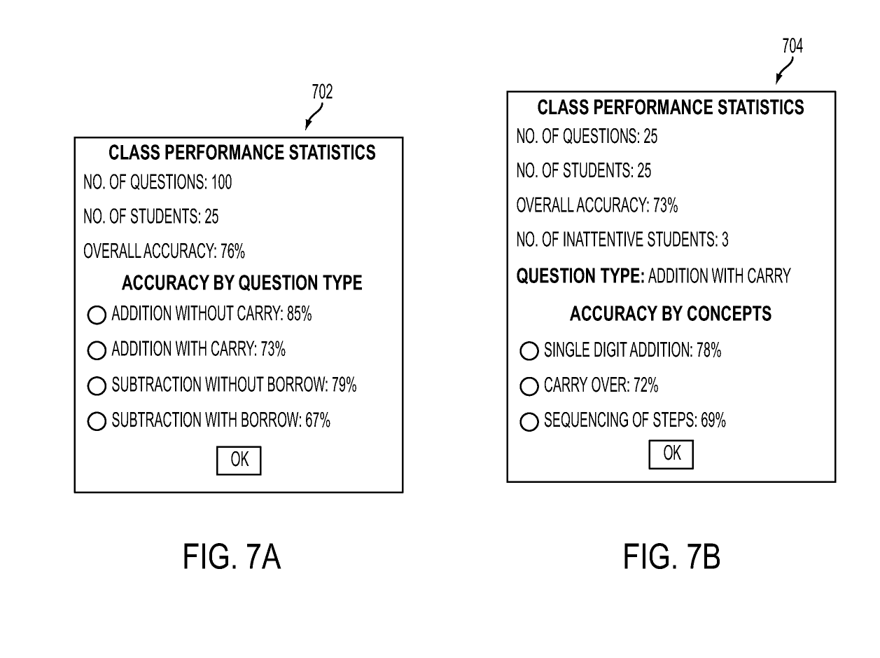

In addition, in an embodiment, the processor 202 may also send statistics associated with the attempt of the question by the user to the application server 102. The application server 102 may compile such statistics from multiple user-computing devices (such as 108a, 108b, etc.) and send aggregate level statistics and individual statistics pertaining to the attempt of the question by the one or more users to the trainer-computing device 106. Examples of the statistics may include, but are not limited to, statistics pertaining to the evaluation report and the time stamps associated with each input provided by the user. Examples of user-interfaces presented to the trainer/expert user on the trainer-computing device 106 have been explained in conjunction with FIGS. 7A and 7B.

A person skilled in the art would understand that the examples of the contents of the evaluation report are for illustrative purposes only and should not be construed to limit the scope of the disclosure. The disclosure may be implemented with various other contents being included (or one or more of the mentioned contents being excluded) in the evaluation report.

At step 322, a training content is presented to the user based on the evaluation of the user. In an embodiment, the processor 202 is configured to present the training content to the user on the display device 212 of the user-computing device (e.g., 108a). In an embodiment, the processor 202 may retrieve the training content from the application server 102 (or the database server 104) based on the evaluation of the user. For example, based on the evaluation of the user on a question of two 2-digit numbers, the processor 202 determines that the user commits mistakes in calculating the carry-over digit from the one's place. Thus, the processor 202 may determine that the first concept in which the user is not conversant is single digit addition with carry-over. Hence, the processor 202 may retrieve such training content from the application server 102 (or the database server 104), which may help the user in understanding the first concept, i.e., single addition with carry-over. For example, the training content may include sample questions, illustrations of methods to solve such questions, tips and tricks, and common mistakes. In addition, in an embodiment, the processor 202 may retrieve a second question from the application server 102 (or the database server 104) based on the evaluation of the user. For example, the processor 202 may retrieve another question for addition of two 2-digit numbers, where there is carry-over involved. Thereafter, the processor 202 may present the second question to the user on the display device 212. The processor 202 may then evaluate the user on the second question, in a manner similar to that described earlier.

FIG. 4 illustrates an example of a template 400 associated with a question, in accordance with at least one embodiment.

As is evident in FIG. 4, the template 400 relates to a question of an addition of two 2-digit numbers A_{T} A_{O} (depicted by 402) and B_{T} B_{O} (depicted by 404), where A_{T} and B_{T} are the ten's place digits of the two numbers and A_{O} and B_{O} are the one's place digits of the two numbers. The carry-over digits to the ten's place (C_{T}) and the hundreds (C_{H}) place are depicted by 406. Further, the result of the addition is a third number S_{H} S_{T} S_{O} (depicted by 408), which may be a two digit number (i.e., S_{H}=0) or a three digit number (i.e., S_{H}≠0) depending on the carry-over digits 406. The trainer/expert user may formulate the predefined set of rules for the template. As discussed earlier, the predefined set of rules may include, but are not limited to, one or more predefined inputs for the each of the one or more correct steps of solving the question and a predefined sequence in which the one or more correct steps are to be performed to solve the question. In the current scenario, the one or more correct steps may include the following:

Step 1: S_{O}=(A_{O}+B_{O})/10 (1)

Step 2: C_{T}=(A_{O}+B_{O}) modulus 10 (2)

Step 3: S_{T}=(A_{O}+B_{O}+C_{T})/10 (3)

Step 4: C_{H}=(A_{O}+B_{O}+C_{T}) modulus 10 (4)

Step 5: S_{H}=C_{H} (5)

Further, in the current scenario, the predefined sequence of the one or more correct steps may correspond to the sequence Step 1->Step 2->Step 3->Step 4->Step 5. In an embodiment, the one or more predefined inputs may be determined by evaluating the equation related to each step based on the actual values of the two numbers in the question. For instance, a question related to this template is that of the addition of the two digit numbers 24 and 58. Based on the equation 1, the processor 202 may evaluate the predefined input for the Step 1 (i.e., S_{O}) as 2. Similarly, using equation 2, the processor 202 may evaluate the predefined input for the Step 2 (i.e., C_{T}) as 1, and so on.

A person skilled in the art would appreciate that the predefined sequence of the one or more correct steps may be common for all questions related to the template. However, the one or more predefined inputs pertaining to each of the one or more correct steps may be specific to the question. In an embodiment, the processor 202 may determine the one or more predefined inputs for each of the one or more correct steps by utilizing a predefined rule associated with each of the one or more correct steps. In an embodiment, the predefined rule may be common for all questions related to the template; however, the one or more predefined inputs may vary based on the underlying values in the question. For example, in the current scenario, the predefined rule for determining the predefined inputs for step 1 is defined by equation 1. Similarly, the predefined rule for determining the predefined inputs for step 2 is defined by equation 2, and so on.

In an embodiment, the at least one step may conform to the predefined set of rules, when the one or more inputs provided by the user for performing the at least one step are same as the one or more predefined inputs for the corresponding correct step, as determined by the processor 202, and the order of the one or more steps performed by the user (including the at least one step) for solving the question is same as the predefined sequence of the one or more correct steps for solving the question. However, in some scenarios, the user may not provide inputs for each step, i.e., the user may skip steps, but still manage to arrive at the correct answer. For example, the user skips step 2 and step 4 and mentally records the carry-over digits without providing a corresponding input. However, the user may still be able to provide the correct result for the question. In such a scenario, the processor 202 may evaluate the user based on the sequence of the rest of the steps performed by the user and whether the inputs provided by the user are in accordance with the one or more predefined inputs pertaining to the respective steps. Further, the processor 202 may provide a feedback to the user indicating that the user skipped steps while solving the question. In addition, the processor 202 may award a bonus score to the user if the user provides the correct answer in spite of skipping steps. In an embodiment, the trainer/expert user may specify a first set of steps from the one or more correct steps as necessary steps and a second set of steps from the one or more correct steps as optional steps. The predefined set of rules may include information indicative of the first set of steps and the second set of steps. In an embodiment, the processor 202 may evaluate the user skipping one or more steps of the question based on whether the skipped steps belong to the first set of steps or the second set of steps. For example, in the current scenario, the first set of steps may include the steps 1, 3, and 5, while the second set of steps may include the steps 2 and 4. Thus, if the user skips step 2 or 4 (i.e., mentally calculates/records the carry-over digits without providing a corresponding input), while providing the correct inputs for the other steps, the processor 202 may evaluate the user as providing a correct answer to the question. However, if the user skips steps 1, 3, or 5 (if required), the processor 202 may evaluate the user as providing an incorrect answer, as he/she does not provide essential inputs for solving the question. An example of a user-interface presenting a question related to the template 400 is explained in conjunction with FIG. 5.

A person skilled in the art would appreciate that the template 400 is an example template for illustrative purposes only and should not be construed to limit the scope of the disclosure. Though the template 400 is related to a question of two-digit addition, the disclosure may be implemented with templates for any type of question from any field/domain such as, but not limited to, mathematics, science, political sciences, sociology, physiology, psychology, social sciences, history, languages, computer science, literature, arts, etc.

FIG. 5 illustrates an example of a user-interface 500 presenting a question 502 related to the template 400 to the user, in accordance with at least one embodiment.

In an embodiment, the question 502 may be a multiple-choice question (MCQ) with two or more options as probable answers. The user may have to select a correct answer (or a best answer, in case of more than one correct answers) from the options. In another embodiment, the MCQ may have multiple correct answers in the options and the user may be required to select each correct answer from among the options. For example, as shown in FIG. 5, the question 502 is a MCQ (“What is 76+85?”) with four options A) 151, B) 161, C) 61, and D) 162 (denoted by 504). The user-interface may include a rough work area 512, enabling the user to perform one or more steps to solve the question. The user may provide the one or more inputs pertaining to the at least one step in the rough work area 512. In an embodiment, the one or more sensors 210 may monitor the one or more inputs provided by the user in the rough work area 512. Further, the one or more sensors 210 may monitor the one or more facial expressions of the user as the user solves the question, by providing inputs in the rough work area 512. The processor 202 may evaluate the user on the question based on the at least one step and the predefined set of rules, as explained in conjunction with FIG. 3. Further, the processor 202 may provide the user with the feedback related to the evaluation and/or the monitoring of one or more facial expressions of the user.

Once the user solves the question in the rough work area 512, the user may select an option from the four options as the correct answer for the question. For example, the user may select the option B (i.e., 161) as the correct answer. Thereafter, the user may submit his/her answer by using a submit button 508. The user may access a previous question or a subsequent question by using a previous button 506 and a next button 510, as shown in FIG. 5.

A person skilled in the art would appreciate that the processor 202 may provide the feedback to the user after the user has selected an option or submitted the question. Alternatively, the processor 202 may provide the user with the feedback while the user is solving the question in the rough work area 512.

In an embodiment, the processor 202 may determine the first set of concepts/sub-concepts (with which the user is not conversant) and the second set of concepts/sub-concepts (with which the user is conversant) based on an analysis of one or more distractors related to the question 502 and the option marked by the user (or the one or more inputs provided by the user in the rough work area 512). In an embodiment, the various options 504 may include the one or more distractors related to the question 502 (i.e., options that are incorrect answers) in addition to the correct answer to the question 502. For example, the options A) 151, C) 61, and D) 162 are the one or more distractors related to the question 502. Each distractor may be associated with a mistake that may be committed on a particular concept/sub-concept related to the question. For example, if the user forgets the carry-over digit from the one's place to the ten's place then he/she might mark the option A (i.e., 151). Similarly, the user might mark the option C (i.e., 61) if he/she forgets the carry-over digit from the ten's place to the hundreds place. As the option D (i.e., 162) is related to a mistake in the concept of a simple addition of two digits, the user may be expected to be at least conversant with this concept. Thus, when the user marks the option D, the user may have been distracted. A person skilled in the art would appreciate that the degree of attentiveness of the user may be used to validate whether a mistake committed by the user is due to lack of attention/interest.

A person skilled in the art would appreciate that though the question 502 has been depicted as an MCQ, the scope of the disclosure is not limited to the question 502 being an MCQ. The question 502 may be any type of question such as, but not limited to, an essay type question, a reading comprehension question, a long-answer type question, a question with subjective answers, and so on.

FIGS. 6A, 6B, and 6C depict an example scenario 600 of monitoring the one or more facial expressions of a user 602 by the one or more sensors 210 of the user-computing device (e.g., 108a), in accordance with at least one embodiment.

FIG. 6A depicts the user 602 looking towards the display device 212 of the user-computing device (e.g., 108a), while solving the question.

FIG. 6B depicts the one or more facial expressions of the user 602 being monitored by the one or more sensors 210 of the user-computing device (e.g., 108a), while the user 602 solves the question. In an embodiment, the one or more sensors 210 may include a camera/video recorder that captures a video stream of the user 602 to monitor the one or more facial expressions of the user 602, while he/she solves the question.

FIG. 6C depicts a region of interest 604 in a representative frame of the captured video stream of the monitored one or more facial expressions of the user 602. As shown in FIG. 6C, the region of interest 604 includes the face of the user 602. A graphical overlay 606 on the face of the user 602 may be representative of a facial region that may be tracked/monitored by the processor 202 for determining the degree of attentiveness of the user 602. Further, the processor 202 may also track/monitor a region enclosed in a pair of elliptical overlays 608 encircling the eyes of the user 602 for determining the degree of attentiveness of the user 602. In an embodiment, the processor 202 may determine the degree of attentiveness of the user 602 by utilizing one or more image processing techniques and/or one or more machine learning techniques known in the art. The monitoring of the one or more facial expressions of the user 602 and the determination of the degree of attentiveness of the user 602 has been explained in step 308 (FIG. 3).

A person skilled in the art would appreciate that the scope of the disclosure should not be limited to the example scenario 600, as described above. The disclosure may be implemented with one or more variations without departing from the spirit of the disclosure.

FIGS. 7A and 7B illustrate examples of user-interfaces that may be presented to the trainer/expert user on the trainer-computing device 106, in at least one embodiment.

FIG. 7A depicts a user-interface 702 that may be presented on the trainer-computing device 106 to display statistics pertaining to the evaluation of the one or more users on the one or more questions. In an embodiment, the trainer-computing device 106 may receive the statistics from the application server 102 at regular intervals (or at intervals specified by the trainer/expert user, for example, when the users solve a given number of questions). In an embodiment, the statistics may include the evaluation reports of individual users at an individual level and at an aggregate level. For example, as shown in FIG. 7A, the statistics relate to 100 questions presented to each of the one or more users (25 users). The overall accuracy of the 25 users on the 100 questions, based on the evaluations of the individual users on each question, is 76%. Statistics related to the accuracy of the users on the questions may be segregated based on the question type. For instance, accuracy of the users on questions of the type addition without carry is 85%, addition with carry is 73%, subtraction without borrow is 79%, and subtraction with borrow is 67%. The trainer/expert user may wish to drill down on the questions of a specific type to view statistics related to that question type in particular. To that end, the trainer/expert user may select a check box corresponding to the particular question type through the user-interface 702. For example, if the trainer/expert user selects the check box corresponding to the question type “addition with carry”, the trainer/expert user may be presented with a user-interface 704, which may display statistics pertaining to that question type.

FIG. 7B depicts the user-interface 704 that may be presented on the trainer-computing device 106 to display the statistics pertaining the questions of a particular type. In an embodiment, the user-interface 704 may be presented to the trainer/expert user in response to the trainer/expert user selecting a question type (by selecting a relevant check box in the user-interface 702) on which the trainer/expert user requires statistics. In an embodiment, the trainer-computing device 106 may receive such statistics from the application server 102 at regular intervals (or at intervals specified by the trainer/expert user, for example, when the users solve a given number of questions of that type). For example, as shown in FIG. 7B, the user-interface 704 presents the statistics pertaining to the questions of type “addition with carry”. As shown in FIG. 7B, when 25 users were evaluated on 25 questions of the type “addition with carry”, the overall accuracy of the users on these questions was 73%. Further, 3 of the 25 users were detected as inattentive, i.e., bored, distracted, etc. (based on the degree of attentiveness determined by the processor 202 for the individual users) Accuracy by concepts relates to the first and the second set of concepts/sub-concepts identified for each user. As discussed above, the processor 202 determines the first set of concepts/sub-concepts, with which a user is not conversant, and the second set of concepts/sub-concepts, with which the user is conversant. Thus, if a particular concept/sub-concept belongs to the second set of concepts/sub-concepts for the user, the processor 202 may evaluate the user as accurate with respect to that concept/sub-concept. Similarly, for a concept/sub-concept belonging to the first set of concepts/sub-concepts for the user, the processor 202 may evaluate the user as inaccurate with respect to that concept/sub-concept. As shown in FIG. 7B, 78% of the users were accurate on the concept of a single digit addition, i.e., 78% of the total users were conversant with the concept of single digit addition. Similarly, the concepts of carry-over and sequencing of steps were clear to 72% and 69% of the users, respectively.

A person skilled in the art would appreciate that the user-interfaces 702 and 704 are examples for illustrative purpose only and should not be construed to limit the scope of the disclosure. The user-interfaces 702 and 704 may be implemented with one or more variations without departing from the scope of the disclosure. Further, the user-interfaces 702 and 704 may include a variety of information pertaining to the evaluation report of the user such as, but not limited to, a feedback pertaining to the at least one step, the number of revisions pertaining to the at least one step, a time elapsed between a first revision and a second revision pertaining to said at least one step, a time elapsed between the receipt of the one or more inputs pertaining to the at least one step and one or more second inputs pertaining to the step subsequent to the at least one step (or time taken in each step), a sequence in which one or more steps are performed by the user for solving the question, a step skipped by the user while solving the question, and the degree of attentiveness of the user while solving the question.

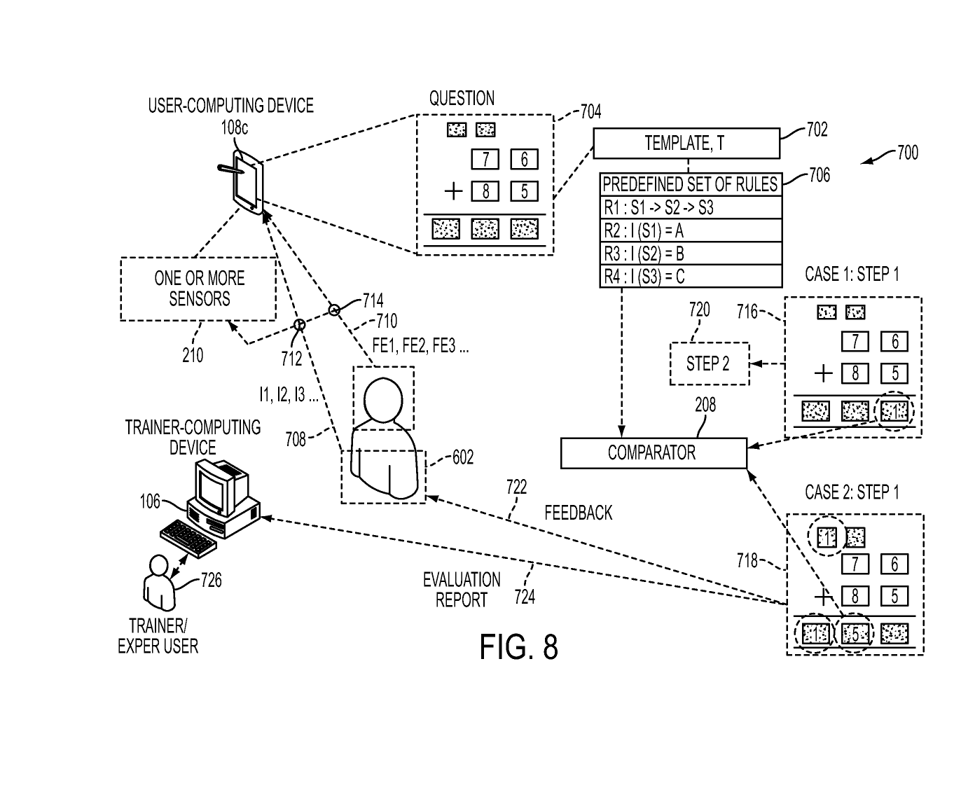

FIG. 8 is a flow diagram illustrating the evaluation of the user 602 on a question 704, in at least one embodiment.

As shown in FIG. 8, the user-computing device (e.g., 108c) presents the question 704 through the user-interface on the display device 212. For example, as shown in FIG. 8, question 704 is that of addition of two 2-digit numbers (i.e., 76 and 85). In an embodiment, the question 704 is related to a template, T (depicted by 704). In an embodiment, the trainer/expert user 726 provides a predefined set of rules (depicted by 706) for the template, T (depicted by 704). An example of the template, T (depicted by 704) and the predefined set of rules (depicted by 706) has been explained in conjunction with FIG. 4. The user 602 provides the one or more inputs (e.g., inputs I1, I2, I3 . . . ; depicted by 708) pertaining to the at least one step. In an embodiment, the one or more sensors 210 of the user-computing device (e.g., 108c) may monitor (depicted by 712) the one or more inputs 708 provided by the user 602. For example, the one or more sensors 210 include a touch screen that captures the one or more inputs (depicted by 708) provided by the user 602 and the region on the touch screen where the user 602 provides these inputs 708. Further, in an embodiment, the one or more sensors 210 may monitor (depicted by 714) the one or more facial expressions (e.g., FE1, FE2, FE3 . . . ; depicted by 710) of the user 602. The monitoring of the one or more inputs 708 of the user 602 (depicted by 712) and the monitoring of the one or more facial expressions 710 of the user 602 (depicted by 714) by the one or more sensors 210 has been explained further in conjunction with FIG. 3.

Once the user 602 provides the one or more inputs 708 (pertaining to the at least one step), the processor 202 of the user-computing device (e.g., 108c) may determine whether the at least one step is in accordance with the predefined set of rules 706. Thus, the processor 202 may utilize the comparator 208 to check the at least one step against the predefined set of rules 706. To that end, the comparator 208 may compare the predefined inputs of the one or more correct steps with the one or more inputs 708 and the ordering of the at least one step (with respect to the other steps performed by the user 602) with the predefined sequence of the one or more correct steps. Based on the determination that whether the at least one step is in accordance with the predefined set of rules 706, the processor 202 may evaluate the user 602 on the question 704, as has been explained in conjunction with FIG. 3.

Two use cases (716 and 718) have been depicted in FIG. 8. In case 1 (depicted by 716), the user 602 may provide a correct input for the at least one step such that the ordering of the at least one step is also correct. For example, the user 602 provides the correct digit (i.e., 1) at the one's place as the input for the at least one step. Thus, in case 1, the user-computing device (e.g., 108c) may enable the user 602 to provide inputs for the next steps (e.g., a step 2, depicted by 720). In case 2 (depicted by 718), the user 602 may provide inputs such that the ordering of steps is wrong. Further, due to wrong ordering of the steps, one or more of the individual inputs may also be wrong. For example, the ordering of the steps performed by the user 602 is wrong as the user adds the ten's digits of the two numbers before adding the one's digits of the two numbers. Consequently, the input provided for the ten's place (i.e., 5) by the user 602 is wrong. The user 602 may, however, provide a correct input for the carry-over digit from the ten's place (i.e., 1) and a consequent correct input for the hundred's place (i.e., 1). In this case (case 2), the processor 202 may identify “ordering of steps” as the first set of concepts/sub-concepts with which the user 602 in not conversant. Further, the processor 202 may identify that the user 602 is conversant with “single digit addition” and “single digit addition with carry-over”. Thus, the second set of concepts/sub-concepts with which the user is conversant may include “single digit addition” and “single digit addition with carry-over”. Thereafter, the processor 202 may provide a feedback 722 to the user 602. Further, the processor 202 may provide an evaluation report 724 to the trainer/expert user 726 on the trainer-computing device 106. The aspect of providing the feedback 722 to the user 602 and the evaluation report 724 to the trainer/expert user 726 has been further explained in conjunction with FIG. 3.

Various embodiments of the disclosure encompass numerous advantages including fine-grained evaluation of a user on various concepts/sub-concepts related a question. As discussed, the user may attempt the question by providing one or more inputs through a user-interface of his/computing device. One or more sensors in the user's computing device may monitor one or more inputs received from the user, while the user performs at least one step of the question. Thereafter, the at least one step is checked against a predefined set of rules for solving the question. As discussed, the predefined set of rules may include correct inputs associated with each step involved in solving the question, in addition to a correct sequencing of such steps. Thus, the user may be evaluated in real-time, if he/she provides a wrong input or performs steps in an incorrect order. Such real-time evaluation of the user may be useful for ascertaining a first set of concepts/sub-concepts with which the user is not conversant and a second set of concepts/sub-concepts with which the user is conversant. Further, in case of Multiple Choice Questions (MCQ), such evaluation may help in scenarios where the user either does not reach a final answer or reaches an answer that is not among the list of options provided for the MCQ.

Further, as discussed above, while the user attempts the question, the one or more sensors in the user's computing device may monitor one or more facial expressions of the user. Thereafter, based on the one or more facial expressions, a degree of attentiveness of the user is determined. Based on the degree of attentiveness, the user's computing device may provide a feedback to the user, to alert the user and bring back his/her attention to the question. Further, the evaluation of the user on the question may be validated based on the degree of attentiveness of the user. For example, if the user is found to be inattentive (e.g., bored, distracted, etc.), the user's computing device may attribute the user's mistake (if any) on the question to the inattentiveness, rather than to lack of clarity on concepts.

The disclosed methods and systems, as illustrated in the ongoing description or any of its components, may be embodied in the form of a computer system. Typical examples of a computer system include a general purpose computer, a programmed microprocessor, a micro-controller, a peripheral integrated circuit element, and other devices, or arrangements of devices that are capable of implementing the steps that constitute the method of the disclosure.

The computer system comprises a computer, an input device, a display unit, and the internet. The computer further comprises a microprocessor. The microprocessor is connected to a communication bus. The computer also includes a memory. The memory may be RAM or ROM. The computer system further comprises a storage device, which may be a HDD or a removable storage drive such as a floppy-disk drive, an optical-disk drive, and the like. The storage device may also be a means for loading computer programs or other instructions onto the computer system. The computer system also includes a communication unit. The communication unit allows the computer to connect to other databases and the internet through an input/output (I/O) interface, allowing the transfer as well as reception of data from other sources. The communication unit may include a modem, an Ethernet card, or similar devices that enable the computer system to connect to databases and networks such as LAN, MAN, WAN, and the internet. The computer system facilitates input from a user through input devices accessible to the system through the I/O interface.

To process input data, the computer system executes a set of instructions stored in one or more storage elements. The storage elements may also hold data or other information, as desired. The storage element may be in the form of an information source or a physical memory element present in the processing machine.

The programmable or computer-readable instructions may include various commands that instruct the processing machine to perform specific tasks such as steps that constitute the method of the disclosure. The systems and methods described can also be implemented using only software programming, only hardware, or a varying combination of the two techniques. The disclosure is independent of the programming language and the operating system used in the computers. The instructions for the disclosure can be written in all programming languages including, but not limited to, “C,” “C++,” “Visual C++,” and “Visual Basic”. Further, software may be in the form of a collection of separate programs, a program module containing a larger program, or a portion of a program module, as discussed in the ongoing description. The software may also include modular programming in the form of object-oriented programming. The processing of input data by the processing machine may be in response to user commands, the results of previous processing, or from a request made by another processing machine. The disclosure can also be implemented in various operating systems and platforms, including, but not limited to, “Unix,” “DOS,” “Android,” “Symbian,” and “Linux.”

The programmable instructions can be stored and transmitted on a computer-readable medium. The disclosure can also be embodied in a computer program product comprising a computer-readable medium, with any product capable of implementing the above methods and systems, or the numerous possible variations thereof.

Various embodiments of the methods and systems for evaluating a user have been disclosed. However, it should be apparent to those skilled in the art that modifications, in addition to those described, are possible without departing from the inventive concepts herein. The embodiments, therefore, are not restrictive, except in the spirit of the disclosure. Moreover, in interpreting the disclosure, all terms should be understood in the broadest possible manner consistent with the context. In particular, the terms “comprises” and “comprising” should be interpreted as referring to elements, components, or steps, in a non-exclusive manner, indicating that the referenced elements, components, or steps may be present, used, or combined with other elements, components, or steps that are not expressly referenced.

A person with ordinary skills in the art will appreciate that the systems, modules, and sub-modules have been illustrated and explained to serve as examples and should not be considered limiting in any manner. It will be further appreciated that the variants of the above disclosed system elements, modules, and other features and functions, or alternatives thereof, may be combined to create other different systems or applications.

Those skilled in the art will appreciate that any of the aforementioned steps and/or system modules may be suitably replaced, reordered, or removed, and additional steps and/or system modules may be inserted, depending on the needs of a particular application. In addition, the systems of the aforementioned embodiments may be implemented using a wide variety of suitable processes and system modules, and are not limited to any particular computer hardware, software, middleware, firmware, microcode, and the like.

The claims can encompass embodiments for hardware and software, or a combination thereof.

It will be appreciated that variants of the above disclosed, and other features and functions or alternatives thereof, may be combined into many other different systems or applications. Presently unforeseen or unanticipated alternatives, modifications, variations, or improvements therein may be subsequently made by those skilled in the art that are also intended to be encompassed by the following claims.

What is claimed is:

1. A method for evaluating a user on a question, the method comprising:
in a mobile device:
monitoring, by one or more sensors in said mobile device, one or more inputs, received from said user, pertaining to at least one step performed for solving said question;
monitoring, by said one or more sensors, one or more facial expressions of said user, while said user is attempting said question, wherein said one or more facial expressions are analyzed using one or more image processing techniques;
determining, by one or more processors in said mobile device, if said at least one step is in accordance with a predefined set of rules deterministic of one or more correct steps involved in solving said question; and
evaluating, by said one or more processors, said user on said question based at least on said determination and said analysis of said one or more facial expressions.

2. The method of claim 1 further comprising providing, by said one or more processors, a feedback to said user based at least on said determination or said analysis of said one or more facial expressions.

3. The method of claim 1 further comprising determining, by said one or more processors, at least a degree of attentiveness of said user while solving said question, based on said analysis of said one or more facial expressions.

4. The method of claim 3, wherein said degree of attentiveness corresponds to a measure of time for which said user is at least one of bored, distracted, frustrated, confused, or not looking at a screen of said mobile device.

5. The method of claim 1, wherein said evaluating said user further comprises determining, by said one or more processors, at least a first set of concepts/sub-concepts and a second set of concepts/sub-concepts associated with solving said question based on said determination, wherein said user is unconversant with at least said first set of concepts/sub-concepts and said user is conversant with at least said second set of concepts/sub-concepts.

6. The method of claim 1, wherein said predefined set of rules comprises one or more predefined inputs pertaining to each of said one or more correct steps and a predefined sequence in which said one or more correct steps are to be performed to solve said question.

7. The method of claim 1 further comprising monitoring, by said one or more processors, a time elapsed between providing said one or more inputs pertaining to said at least one step and one or more second inputs pertaining to a step subsequent to said at least one step.

8. The method of claim 1 further comprising determining, by said one or more processors, a number of revisions pertaining to said at least one step, and a time elapsed between a first revision and a second revision pertaining to said at least one step, based on said monitoring of said one or more inputs.

9. The method of claim 1 further comprising presenting, by said one or more processors, a training content to said user based on said evaluation of said user on said question.

10. The method of claim 1 further comprising sending, by a transceiver in said mobile device, an evaluation report to an expert user based on said evaluation of said user on said question, wherein said evaluation report includes at least one of a feedback pertaining to said at least one step, a number of revisions pertaining to said at least one step, a time elapsed between a first revision and a second revision pertaining to said at least one step, a time elapsed between a receipt of said one or more inputs pertaining to said at least one step and one or more second inputs pertaining to a step subsequent to said at least one step, a sequence in which one or more steps are performed by said user for solving said question, a step skipped by said user while solving said question, or a degree of attentiveness of said user while solving said question.

11. The method of claim 1, wherein said one or more sensors comprise at least one of a touch screen, an accelerometer, a gyroscope, an audio input device, or a camera/video recorder.

12. A mobile device for evaluating a user on a question, the mobile device comprising:
one or more sensors configured to:
monitor one or more inputs, received from said user, pertaining to at least one step performed for solving said question;
monitor one or more facial expressions of said user, while said user is attempting said question, wherein said one or more facial expressions are analyzed using one or more image processing techniques; and
one or more processors configured to:
determine if said at least one step is in accordance with a predefined set of rules deterministic of one or more correct steps involved in solving said question; and
evaluate said user on said question based at least on said determination and said analysis of said one or more facial expressions.

13. The mobile device of claim 12, wherein said one or more processors are further configured to provide a feedback to said user based at least on said determination or said analysis of said one or more facial expressions.

14. The mobile device of claim 12, wherein said one or more processors are further configured to determine at least a degree of attentiveness of said user while solving said question, based on said analysis of said one or more facial expressions.

15. The mobile device of claim 12, wherein to evaluate said user, said one or more processors are further configured to determine at least a first set of concepts/sub-concepts and a second set of concepts/sub-concepts associated with solving said question based on said determination, wherein said user is unconversant with at least said first set of concepts/sub-concepts and said user is conversant with at least said second set of concepts/sub-concepts.

16. The mobile device of claim 12, wherein said predefined set of rules comprises one or more predefined inputs pertaining to each of said one or more correct steps and a predefined sequence associated with said one or more correct steps in solving said question.

17. The mobile device of claim 12, wherein said one or more processors are further configured to monitor a time elapsed between providing said one or more inputs pertaining to said at least one step and one or more second inputs pertaining to a step subsequent to said at least one step.

18. The mobile device of claim 12, wherein said one or more processors are further configured to determine a number of revisions pertaining to said at least one step, and a time elapsed between a first revision and a second revision pertaining to said at least one step, based on said monitoring of said one or more inputs.

19. The mobile device of claim 12, wherein said one or more sensors comprise at least one of a touch screen, an accelerometer, a gyroscope, an audio input device, or a camera/video recorder.

20. A computer program product for use with a mobile device, the computer program product comprising a non-transitory computer readable medium, wherein the non-transitory computer readable medium stores a computer program code for evaluating a user on a question, wherein the computer program code is executable by one or more processors in said mobile device to:
monitor, by one or more sensors in said mobile device, one or more inputs, received from said user, pertaining to at least one step performed for solving said question;
monitor, by said one or more sensors, one or more facial expressions of said user, while said user is attempting said question, wherein said one or more facial expressions are analyzed using one or more image processing techniques;
determine, by said one or more processors, if said at least one step is in accordance with a predefined set of rules deterministic of one or more correct steps involved in solving said question; and
evaluate, by said one or more processors, said user on said question based at least on said determination and said analysis of said one or more facial expressions.

21. The computer program product of claim 20, wherein to evaluate said user, said computer program code is further executable by said one or more processors to determine at least a first set of concepts/sub-concepts and a second set of concepts/sub-concepts associated with solving said question based on said determination, wherein said user is unconversant with at least said first set of concepts/sub-concepts and said user is conversant with at least said second set of concepts/sub-concepts.
